(19) United States
(12) Patent Application Publication
(10) Pub. No.: US 2020/0078916 A1
(43) Pub. Date: Mar. 12, 2020

(54) Distributed Deadblow Tools

(71) Applicant: Todd Henry Doner, Bentonville, AR (US)

(72) Inventor: Todd Henry Doner, Bentonville, AR (US)

(21) Appl. No.: 16/129,766

(22) Filed: Sep. 12, 2018

(51) Int. Cl. B25D 1/12; B25D 1/14; B26B 23/00

(52) U.S. Cl. CPC B25D 1/12; B25D 1/04; B26B 23/00; B25D 1/14

(57) ABSTRACT

A deadblow tool, comprising a head with one or more striking surfaces; a handle joined to or molded as one with the head; a plurality of hollow chambers within the tool embodiment; a plurality of freely moveable material partially filling the hollow chambers; and an embodiment in the form of a hammer, mallet, axe, or annular maul. The tool has hollow chambers created as part of the tool embodiment or created separately as chamber cartridges to be inserted into the tool embodiment. The hollow chambers and chamber cartridges vary in size and shape and the freely moveable material varies in density and volume to accommodate mass distribution and the adjustments thereof provide facilitation to further tune the tool balance and strike performance. Construction methods of chamber cartridges and deadblow handles, hammers, mallets, axes, and mauls are also provided.

### CROSS-REFERENCE TO RELATED APPLICATIONS

N/A

### BACKGROUND OF THE INVENTION

### 1. Field of the Invention

The present invention is in the field of striking hand tools including hammers, mallets, axes, and annular mauls and pertains particularly to balance and antirecoil characteristics of deadblow tools.

### 2. Description of Related Art

Deadblow (aka dead-blow, non-recoil, anti-recoil, no-bounce, or recoilless) tools, such as hammers, mallets, axes, and mauls, are well known to significantly reduce rebound by distributing the strike over time; thereby reducing the peak force and absorbing a significant amount of the recoil that would otherwise be returned through rebound to the user's hands and arms. Deadblow tools are used in many industries, including but not limited to, auto repair, hydraulic maintenance, aerospace work, telecommunications cable work, woodworking, woodcarving, metalworking, and surgical procedures.

Prior-art deadblow tools are comprised of a single hollow chamber or identical dual back-to-back hollow chambers to form a head, a plurality of freely moveable filler material, such as sand or steel shot, to partially fill the head, and an attached handle or a handle molded as one with the head. Many times deadblow tools are also fully or partially encased in a layer of plastic or rubber-like substance, or have non-marring tips attached to the striking face(s) on one or both ends of the head, or are cast as traditional steel tools with chamber(s) molded therein to partially fill with freely moveable material.

The operation of a deadblow tool functions as follows: a user swings the tool to strike, as the tool thrusts forward, the freely moveable filler material shifts to the back of the chamber, as the tool comes into contact with (strikes) a surface, the tool rebounds (bounces back, Newton's 3rd Law), but due to inertia, the freely moveable filler material continues to move forward, shifting from the back of the chamber to strike the front of the chamber; thereby, dampening or reducing or counteracting the rebound.

Prior-Art deadblow tools are limited in several ways:
no controls to balance the freely moveable material within the tool,
leaving the user to physically compensate;
no controls to eliminate freely moveable material from pooling or settling in one area of the chamber, requiring more effort to move the depth of freely moveable material as is evident when striking with a deadblow tool horizontally;
no control to balance the strike across the struck surface resulting in less efficient force transfer as freely moveable material can strike more in one area than another, and in varying amounts, on each strike resulting in lost energy as the freely moveable material is forced to spread out when mounded higher than the freely moveable material in the rest of the chamber; and
no controls to maintain balance while the tool is in motion. Users that swing fast cause the freely moveable material to pool at the farthest point of the chamber due to centrifugal force and users that swing slow cause the freely moveable material to pool at the lowest point of the chamber due to gravity.

### BRIEF SUMMARY OF THE INVENTION

The present invention directly addresses each of the prior-art deadblow tool limitations mentioned above by adding a plurality of distributed chambers, each tunable by location, orientation, shape, and size, as well as, tunable by the weight and volume of the freely moveable material inserted therein. Collectively, these tuning options enable some variation and control in regard to the movement of mass in relation to each chamber's counterstrike or blow as far as when, where, and by how much. Insertable chambers and tool construction methods are also provided.

### BRIEF DESCRIPTION OF THE SEVERAL VIEWS OF THE DRAWINGS

FIGS. 1-4 depict the operating sequence of a single-chamber prior-art deadblow hammer.

FIG. 1 Represents the single-chamber hammer at rest

FIG. 2 Represents the single-chamber hammer being thrust forward by a user.

FIG. 3 Represents the single-chamber hammer at the beginning of a strike.

FIG. 4 Represents the single-chamber hammer at the end of a strike.

FIGS. 5-9 depict the operating sequence of a multi-chamber present-art deadblow hammer.

FIG. 5 Represents the multi-chamber hammer at rest

FIG. 6 Represents the multi-chamber hammer being thrust forward by a user.

FIG. 7 Represents the multi-chamber hammer at the beginning of a strike.

FIG. 8 Represents the multi-chamber hammer at the middle of a strike.

FIG. 9 Represents the multi-chamber hammer at the end of a strike.

FIGS. 10-15 depict examples of the portability of present-art to other striking tools.

FIG. 10 Represents an example multi-chamber claw hammer.

FIG. 11 Represents an example multi-chamber mallet.

FIG. 12 Represents an example multi-chamber hatchet or axe.

FIG. 13 Represents an example multi-chamber drilling or sledge hammer.

FIG. 14 Represents an example multi-chamber annular maul.

FIG. 15 Represents an example multi-chamber handle.

FIGS. 16-22 depict an example twelve chamber deadblow hammer.

FIG. 16 Represents the main body and head end-caps for the twelve chamber deadblow hammer.

FIG. 17 Represents the freely moveable material that can be added to the chambers of the twelve chamber deadblow hammer.

FIG. 18 Represents example chamber cartridges to be partially filled with freely moveable material to be alternatively inserted into the embodiment of the twelve chamber deadblow hammer versus inserting freely moveable material directly into the chambers.

FIG. 19 Represents the top view of the twelve chamber deadblow hammer.

FIG. 20 Represents the side view of the twelve chamber deadblow hammer.

FIG. 21 Represents the front view of the twelve chamber deadblow hammer.

FIG. 22 Represents a wire-frame view of the main body and head end-caps for the twelve chamber deadblow hammer.

FIG. 23 Represents a 6 chamber cartridge deadblow annular maul, a disc-shaped chamber cartridge, and a head cap.

### DETAILED DESCRIPTION OF THE INVENTION

The below description and attached drawings are offered to explain the invention in detail and are not intended to describe or illustrate the only way the invention may be configured, constructed, or used. The invention can be applied to numerous striking tools regardless of tool head shape, like flat, round, ball pein, cross pein, straight pein, blade, magnet nail holders, and claw, as well as size, like tiny jewelry repair hammers, giant sledge hammers, hatchets, and axes, and various materials, like steel, brass, bronze, copper, aluminum, lead, rubber, wood, plastic, and nylon. Furthermore, the chambers can be constructed in numerous ways as well, such as molded, machined, and fabricated, in different shapes, sizes, textures, as well as different shapes at the ends, like a stair-step that would provide similar effects to having separate chambers of differing lengths. And finally, the selection of freely moveable material has many options as well, such as sand, gravel, shot, slag, fluids, gels, and different shapes, densities, and weights regardless if the material is injected directly into the tool chambers or if the material is injected and encased in chamber cartridges to be pressed or inserted into the tool embodiment.

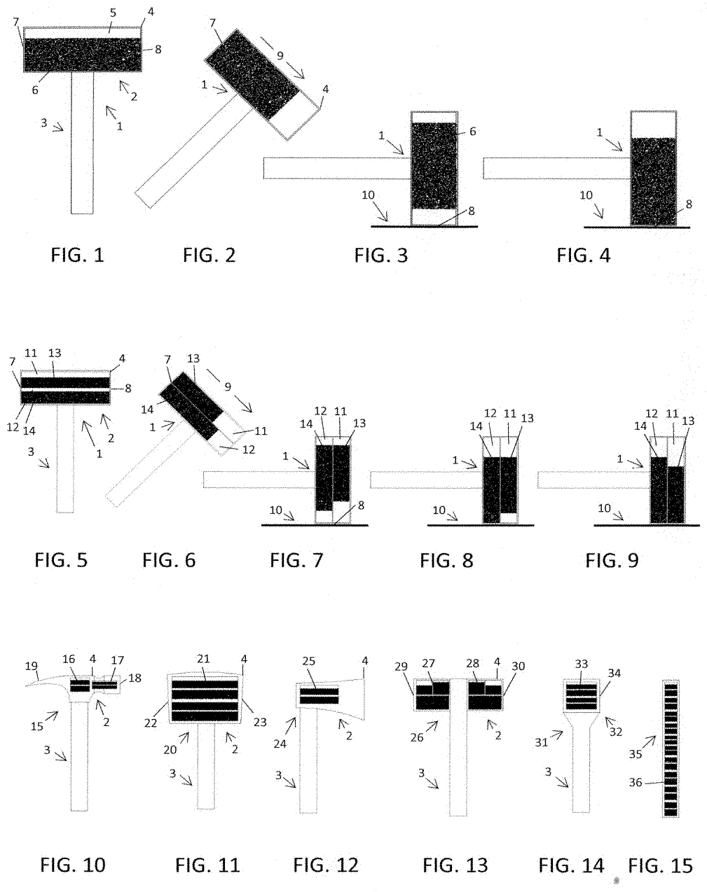

FIG. 1-4 depicts the operating sequence of a single-chamber prior-art deadblow hammer for the importance of describing the difference in present-art.

FIG. 1 is a hammer 1 at rest, with a head 2 on top of a handle 3. The head form 4, also the chamber 4 in this example, is hollow 5 and partially filled with freely moveable material 6 that is settled to the bottom of the chamber 4. The head 2 has two striking surfaces 7 left & 8 right. The handle 3 is for the user to grip while using.

FIG. 2 is a hammer 1 thrusted forward 9, causing the freely moveable material 6 to shift backward to the back of the chamber 4 against the back of the rear striking plate 7.

FIG. 3 is a hammer 1 at the beginning of the strike of surface 10. The initial strike causes the hammer 1 to rebound and the inertia of the freely moveable material 6 causes it to continue to move forward in the chamber 4 towards the back of the front striking plate 8.

FIG. 4 is a hammer 1 at the end of the strike of surface 10, which has caused the hammer 1 to rebound and the freely moveable material 6 to shift to the front of the chamber 4, striking the back of striking plate 8 and thereby deadening the recoil returned from the initial strike.

FIG. 5-9 depicts the operating sequence of a multi-chamber present-art deadblow hammer.

FIG. 5 is a hammer 1 at rest, with a head 2 on top of a handle 3. The head form 4 contains two chambers 11 top and 12 bottom, both are hollow and partially filled with differing amounts of freely moveable material 13 top and 14 bottom that is settled to the bottom of chamber 11 and chamber 12. The head 2 has two striking surfaces 7 left & 8 right. The handle 3 is for the user to grip while using.

FIG. 6 is a hammer 1 thrusted forward 9, causing the freely moveable material 13 and 14 to shift backward to the back of the chambers 11 and 12 against the back of the rear striking plate 7.

FIG. 7 is a hammer 1 at the beginning of the strike of surface 10. The initial strike causes the hammer 1 to rebound and the inertia of the freely moveable material 13 and 14 causes it to continue to move forward in the chambers 11 and 12 towards the back of the front striking plate 8.

FIG. 8 is a hammer 1 at the middle of the strike of surface 10, which has caused the hammer 1 to rebound and the freely moveable material 14 to shift to the front of chamber 12, striking the back of striking plate 8 and thereby deadening the recoil returned from the initial strike. Freely moveable material 14 strikes the back of striking plate 8 ahead of freely moveable material 13 because there is less distance between freely moveable material 14 and striking plate 8 than there is between freely moveable material 13 and striking plate 8.

FIG. 9 is a hammer 1 at the end of the strike of surface 10, which has caused the hammer 1 to rebound and the freely moveable material 14 to shift to the front of chamber 12 and strike the back of striking plate 8 to deaden the recoil returned from the initial strike and at this point, the freely moveable material 13 finishes it's shift to the front of chamber 11, striking the back of striking plate 8 and thereby further deadening the overall recoil returned from the strike.

FIGS. 10-15 depict examples of the application of the present-art to other striking tools. The examples are basic in demonstrating the application and are not intended to undermine the underlying complexity of having a plurality of chambers, in a plurality of shapes and sizes, each containing a plurality of materials, in a plurality of amounts to best configure each tool's performance. Each example operates similar to the example provided in FIG. 5-9 in that the freely moveable material is distributed and each chamber can be tuned to collectively change the duration of the strike. Each example may or may not also be encased in plastic or a rubber-like substance as is common with deadblow tools.

FIG. 10 is a claw hammer 15 at rest, with a head 2 on top of a handle 3. The head form 4 contains four chambers 16 and 17, two chambers 16 in the main body of the head between the striking face 18 and the claw 19, and two smaller chambers 17 directly behind the striking face 18. The four chambers 16 and 17 are hollow and partially filled with differing amounts of freely moveable material. The handle 3 is for the user to grip while using. Similar application would apply for other hammer types with differing options on the hammer faces, such as ball, pein, and picks.

FIG. 11 is a mallet 20 at rest, with a head 2 on top of a handle 3. The head form 4 contains four chambers 21 in the main body of the head between the striking faces 22 and 23. The four chambers 21 are hollow and partially filled with differing amounts of freely moveable material. The handle 3 is for the user to grip while using. Similar application would apply for other mallet types with differing options on the mallet faces.

FIG. 12 is an axe 24 at rest, with a head 2 on top of a handle 3. The head form 4 contains two chambers 25 in the thicker end of the main body of the head near the handle 3. The two chambers 25 are hollow and partially filled with differing amounts of freely moveable material. The handle 3 is for the user to grip while using. Similar application would apply for other axe types with differing options on the axe faces, such as double axes.

FIG. 13 is a drilling or sledge hammer 26 at rest, with a head 2 on top of a handle 3. The head form 4 contains six chambers 27 and 28, three chambers 27 between the handle 3 and the left striking face 29 and three chambers 28 between the handle 3 and the right striking face 30. The six chambers 27 and 28 are hollow and partially filled with differing amounts of freely moveable material. The handle 3 is for the user to grip while using. Similar application would apply for other sledge or drilling types with differing options on the faces.

FIG. 14 is an annular maul 31 at rest, with a cylindrical head 32 on top of a handle 3. The head form 32 contains four chambers 33 in the main body of the head. The chambers 33 are disc shaped to ensure they function in any direction since the tool's striking face 34 encompasses the full diameter of the cylindrical head 32. The four chambers 33 are hollow and partially filled with differing amounts of freely moveable material. The handle 3 is for the user to grip while using. Similar application would apply for other maul types with differing options on the maul face, such as cones.

FIG. 15 is a multi-chamber handle 35 at rest, with a cylindrical shape containing twenty chambers 36 in differing sizes from the top of the handle 35 to the bottom. The handle is simply another form of an annular maul wherein the chambers extend the entire body of the maul. The chambers 36 can be shaped to match the intended purpose of the handle. If the handle 35 is intended to strike in any horizontal direction, the chambers 36 can be disc shaped or horizontally shaped to match the exterior of the handle 35. If the handle 35 is intended to strike in a single horizontal direction, the chambers 36 can be oriented to that direction. If the handle 35 is intended to strike in a vertical direction, the chambers 36 can be oriented to that direction. In any configuration, the chambers 36 are hollow and partially filled with differing amounts of freely moveable material. Handle 35 can be used in any striking tool or could function independently as a maul and can have varying diameters across the handle 35 for different applications.

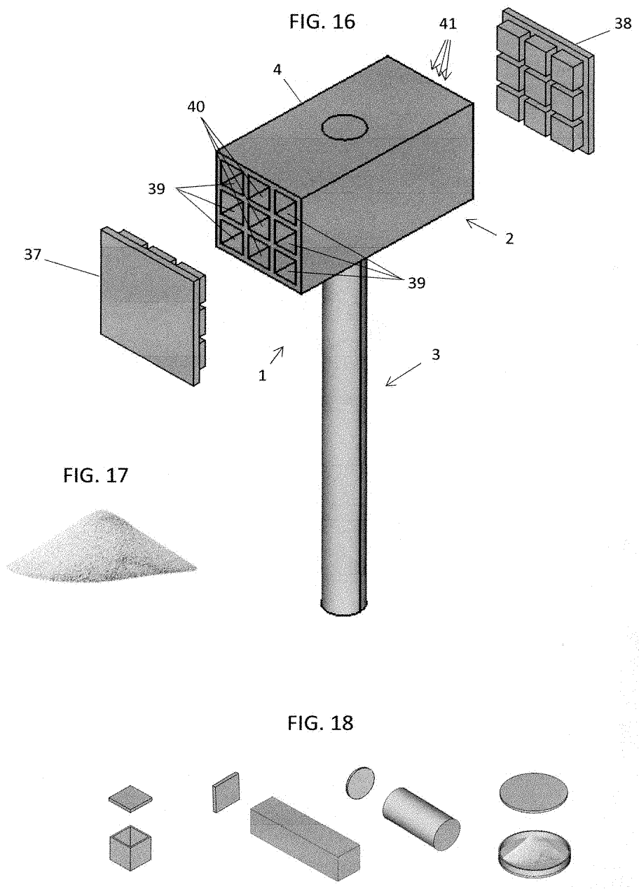

FIGS. 16-24 depict an example twelve chamber deadblow hammer. Twelve chambers is selected for example purposes only, the hammer can have a plurality of chambers. Also depicted are optional externally constructed chamber cartridges that can be inserted into deadblow tool embodiments versus molding chambers and inserting freely moveable material directly therein.

FIG. 16 is an example hammer 1 in exploded view, with head 2 on top of a handle 3, and two attachable striking faces 37-38. The head form 4 contains twelve molded chambers 39-41, six chambers 39 that extend the length of head 2 and six smaller chambers 40-41, three chambers 40 extending from handle 3 to the left side of head 2 and three chambers 41 extending from handle 3 to the right side of head 2. Chambers 39-41 are hollow and can be partially filled with differing amounts of freely moveable material and sealed with the two attachable striking faces, attaching the left striking face 37 to the left side of the head 2 and attaching the right striking face 38 to the right side of the head 2. The handle 3 is for the user to grip while using.

FIG. 17 is an example of freely moveable material that can be inserted into deadblow chambers. Practically any material, preferably dense, can be used. A single solid material will produce a distinct counter-recoil blow and is less effective in recoil absorption; whereas a plurality of smaller materials will produce a less distinct counter-recoil blow and is more effective in recoil absorption. Some commonly used materials are sand and metal shot. Some powders have been found to pack into larger solid materials and become less effective over time. Different shapes can also be used. Round steel shot is common, but round particles will have more unused space around them when packed together than other shapes, requiring larger chambers than if another shape were used. Density and weight is another factor to consider, for example, lead weighs more than steel and steel weighs more than sand. Material must be selected to meet the purpose of the tool and multiple materials can be used within the same tool, especially when working with a multi-chamber tool.

FIG. 18 depicts deadblow chamber cartridges that can be constructed separately and used in a plurality of tools. Chamber cartridges are partially filled with freely moveable material and sealed beforehand. Chamber cartridges can be made in varying shapes and sizes and varying weights and volumes. Multiple versions of the same size chamber cartridge can also be constructed with different tunes, like differing weights and volumes. The use of chamber cartridges would reduce the complexity of manufacturing multi-chamber deadblow tools and would add greater flexibility to tuning. For example, the twelve chambers depicted in FIG. 16 could be reduced to one large cavity that can be filled with chamber cartridges.

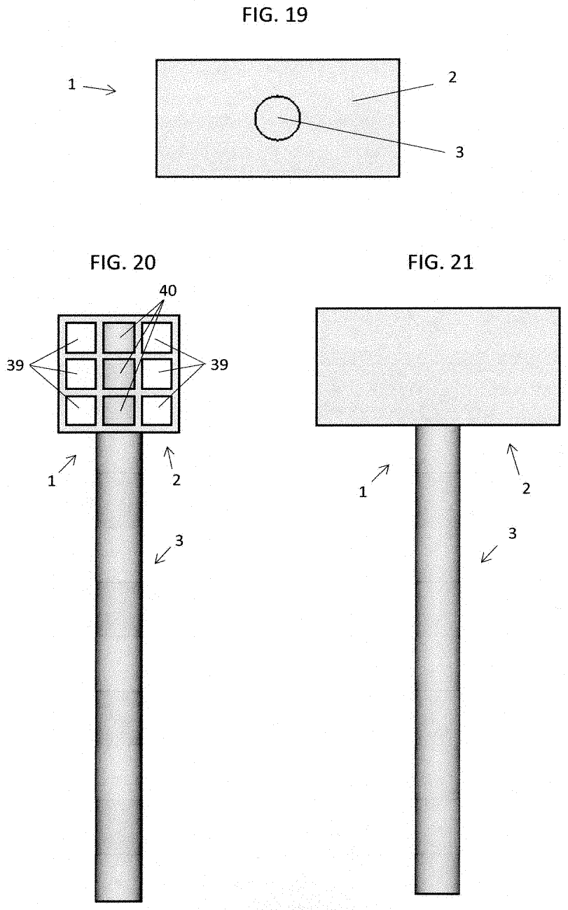

FIG. 19 Represents the top view of the hammer 1 depicted in FIG. 16. In this view the head 2 and handle 3 can be viewed from the top.

FIG. 20 Represents the side view of the hammer 1 depicted in FIG. 16. In this view the head 2, handle 3, and chambers 39-40 can be viewed from the side.

FIG. 21 Represents the front view of the hammer 1 depicted in FIG. 16. In this view the head 2 and handle 3 can be viewed from the front.

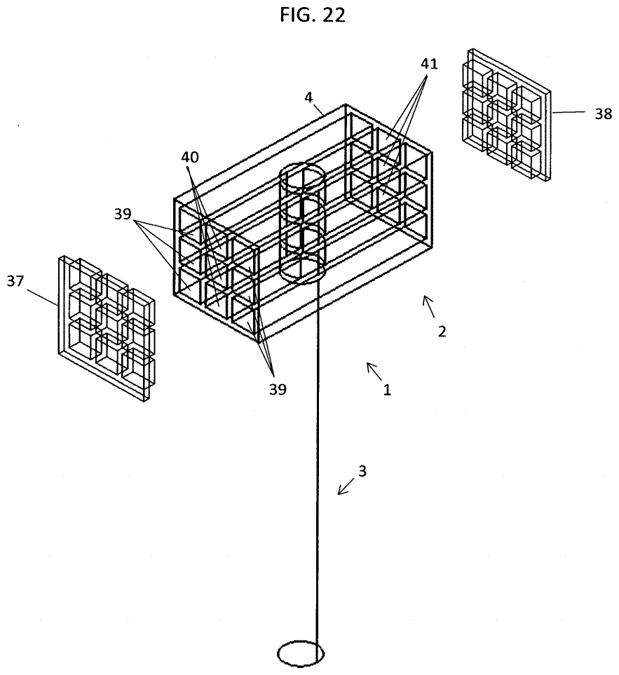

FIG. 22 Represents a wire-frame view of the hammer 1 depicted in FIG. 16. In this view the head 2, handle 3, attachable head faces 37-38, and chambers 39-41 can be viewed internally.

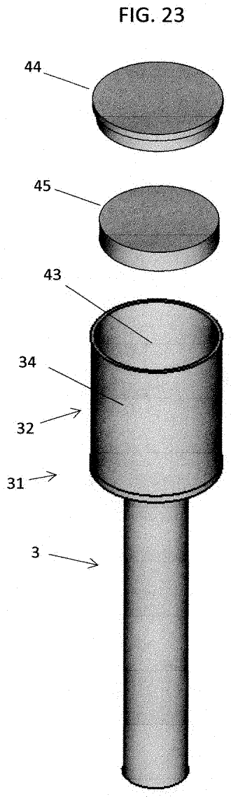

FIG. 23 is an example annular maul 31, with a cylindrical head 32 on top of a handle 3. The head form 32 contains a molded chamber 43 and a chamber cap 44 used to seal the chamber after loading chamber cartridges. The exterior chamber makes up a 360 degree striking face 34. Five disc-shaped chamber cartridges 45 with varying weights and volumes can be loaded into chamber 43. Five chambers were selected for the purpose of demonstration only. The tool can have a plurality of chambers deemed most suitable for the purpose. The handle 3 is for the user to grip while using.

1. A deadblow tool, comprising:
a head with one or more striking surfaces;
a handle joined to or molded as one with the head;
a plurality of hollow chambers within the tool embodiment;
a plurality of freely moveable material partially filling the hollow chambers; and
an embodiment in the form of a hammer, mallet, axe, or annular maul

2. The deadblow tool of claim 1, wherein said hollow chambers are created as part of the tool embodiment.

3. The hollow chambers of claim 2, wherein vary in size and shape to accommodate tool structure and mass distribution, and the adjustments thereof provide facilitation to tune the tool balance and strike performance.

4. The deadblow tool of claim 1, wherein said hollow chambers are created separately as chamber cartridges to be inserted into the tool embodiment.

5. The chamber cartridges of claim 4, wherein vary in size and shape to accommodate tool structure and mass distribution, and the adjustments thereof provide facilitation to tune the tool balance and strike performance.

6. The chamber cartridges of claim 4, are comprised of:
individual containers with one or more hollow compartments;
a plurality of freely moveable material partially filling each hollow compartment; and
of a size and shape to be received by the tool embodiment;

7. The freely moveable material of claim 6, wherein varies in density and volume to further accommodate mass distribution and the adjustments thereof provide facilitation to further tune the tool balance and strike performance.

8. The chamber cartridges of claim 6, wherein construction is comprised of:
a. stamping the container body from sheet metal, molding from plastic, or machining from another substance, in the desired dimensions to hold the freely moveable material;
b. stamping the container lid from sheet metal, molding from plastic, or machining from another substance, in dimensions matching the top of the container and slightly overlapping the container body exterior perimeter;
c. partially filling the container with freely moveable material matching the desired density and amount for the application; and
d. pressing the container lid onto the container opening, thereby sealing the freely moveable material inside the container.

9. The freely moveable material of claim 1, wherein varies in density and volume to further accommodate mass distribution and the adjustments thereof provide facilitation to further tune the tool balance and strike performance.

10. The deadblow tool of claim 1, wherein the embodiment is in a form that accepts a handle. A method of deadblow maul-like handle construction comprises:
a. selecting a tube in the strength, size, and shape desired to accommodate the head;
b. pressing a collection of disc-like chamber cartridges into the handle tube having the chamber and freely moveable material oriented in the direction(s) the handle is intended to strike; and
c. attaching a head and grip to the handle.

11. The deadblow tool of claim 1, wherein the embodiment is a hammer or axe. A method of construction comprises:
a. casting the head with cavities on the top of the head open to accept a plurality of chamber cartridges oriented with the direction(s) of the intended strike;
b. pressing the chamber cartridges into the cast head cavities; and
c. attaching the handle.

12. The deadblow tool of claim 1, wherein the embodiment is a mallet. A method of construction comprises:
a. cutting a segment of metal tubing for the head;
b. cutting a segment of metal rod for the handle;
c. stamping two metal caps matching the shape of the head openings and slightly overlapping the perimeter of said openings to enable pressing onto the head ends;
d. stamping a hole, the size of the handle diameter, through the bottom center of the head;
e. inserting the handle through said hole until it reaches the head top center;
f. welding the rod to the head top center;
g. filling the head with chamber cartridges of the desired size, shape, and weight, with the desired freely moveable material density and volume, oriented in the direction of the intended strike(s);
h. pressing the two caps on each end of the head to make a completed skeleton;
i. placing the skeleton in a mold;
j. encasing the skeleton in a layer of plastic or rubber; and
k. removing the completed mallet.

13. The deadblow tool of claim 1, wherein the embodiment is an annular maul. A method of construction comprises:
a. cutting a segment of metal tubing for the head;
b. cutting a segment of metal rod for the handle;
c. stamping two metal caps matching the shape of the head openings and slightly overlapping the perimeter of said openings to enable pressing onto the head ends;
d. stamping a hole, the size of the handle diameter, through the center of one cap;
e. inserting the handle through said hole until flush with rod end with the overlapping cap material facing away from the handle;
f. welding the cap to the end rod;
g. pressing the head onto the welded cap at the end of the rod;
h. filling the head with disc-shaped chamber cartridges of the desired size, shape, and weight, with the desired freely moveable material density and volume;
i. pressing the second cap on the top of the head to make a completed skeleton;
j. placing the skeleton in a mold;
k. encasing the skeleton in a layer of plastic or rubber; and
l. removing the completed annular maul.

14. The deadblow tool of claim 1, wherein the embodiment is a double annular maul comprising two heads. A method of construction comprises:
a. cutting two segments of metal tubing for the heads;
b. cutting a segment of metal rod for the handle;
c. stamping four metal caps, two matching the shape of the openings of each head and slightly overlapping the perimeter of said openings to enable pressing onto the ends of each head;
d. stamping a hole, the size of the handle, through the center of one cap for each head;
e. inserting the handle through two caps with holes until flush with rod ends and with the overlapping cap material facing outward away from the handle;
f. welding the two caps to each end of the rod;
g. pressing the heads onto the welded caps on each end of the rod;
h. filling the heads with disc-shaped chamber cartridges of the desired size, shape, and weight, with the desired freely moveable material density and volume;
i. pressing the remaining caps onto each head to make a completed skeleton;
j. placing the skeleton in a mold;
k. encasing the skeleton in a layer of plastic or rubber; and
l. removing the completed double annular maul.
